(19) United States
(12) Patent Application Publication
(10) Pub. No.: US 2025/0247482 A1
(43) Pub. Date: Jul. 31, 2025

(54) IMAGE FORMING APPARATUS, IMAGE FORMING METHOD, AND STORAGE MEDIUM

(71) Applicant: CANON KABUSHIKI KAISHA, Tokyo (JP)

(72) Inventor: JUN HORIYAMA, Tokyo (JP)

(21) Appl. No.: 19/022,836

(22) Filed: Jan. 15, 2025

(30) Foreign Application Priority Data
Jan. 25, 2024 (JP) 2024-009511

(51) Int. Cl. H04N 1/00; H04N 1/21

(52) U.S. Cl. CPC H04N 1/0097; H04N 1/00212; H04N 1/00225; H04N 1/00482; H04N 1/21; H04N 2201/0094

(57) ABSTRACT

An apparatus configured to transmit an image in a plurality of methods includes a storage unit configured to store a plurality of settings of the apparatus as composite settings, and a selection unit configured to select one composite setting from among the stored composite settings, wherein the composite settings are defined for each of the plurality of methods.

### BACKGROUND

### Technical Field

The aspect of the embodiments relates to an image forming apparatus that can perform scanning, copying, printing, or a combination of a plurality of these processes, and a control method thereof. For example, the aspect of the embodiments relates to composite settings of setting values.

### Description of the Related Art

In a case where an image forming apparatus that executes a job such as scanning and a facsimile transmission executes a job such as scanning and a facsimile transmission, the image forming apparatus performs various settings such as a color setting and a file format on the job. There is a technique for storing job setting information at logout and referring to it at login to control an operation screen in accordance with user authority. The job setting information is commonly used in job execution protocols (Scan to personal computer (PC)/Scan to Email/Scan to file transfer protocol (FTP)/Scan to Universal Serial Bus (USB), etc.). In other words, even if Scan to USB is used in this time, the setting information set with Scan to PC used last time may be referred to (see Japanese Patent Application Laid-Open No. 2018-148391).

In a case where a job is repeatedly executed with the same setting, such as one used in a routine task, the job setting information can be constantly stored. While jobs with the same setting values are repeatedly executed, it is convenient to save time and effort in setting the job. However, in a method of the above-described technique, for example, there may be a routine task for each job execution protocol (Scan to PC/Scan to Email/Scan to FTP/Scan to USB, etc.). If the setting value is changed to execute the routine task for another protocol, the changed setting value is stored. Thus, if the job for the routine task of the previous protocol is to be executed, there is a need to reconfigure settings, which reduces usability. The job execution protocols described here are examples of various methods for transmitting an image or the like.

In addition, composite settings that include a plurality of setting values cannot be handled.

### SUMMARY

According to an aspect of the embodiments, an apparatus configured to transmit an image in a plurality of methods includes a storage unit configured to store a plurality of settings of the apparatus as composite settings, and a selection unit configured to select one composite setting from among the composite settings stored in the storage unit, wherein the composite settings are defined for each of the plurality of methods.

Further features of the disclosure will become apparent from the following description of exemplary embodiments with reference to the attached drawings.

### BRIEF DESCRIPTION OF THE DRAWINGS

FIG. 1 is an example of a block diagram illustrating a hardware configuration of an image forming apparatus.

FIG. 2 is a block diagram illustrating a software configuration of the image forming apparatus.

FIG. 3 is an example of a flowchart illustrating processing of an image forming apparatus according to a first exemplary embodiment.

FIG. 4 illustrates an example of an operation unit of the image forming apparatus according to the first exemplary embodiment.

FIGS. 5A and 5B illustrate other examples of the operation unit of the image forming apparatus according to the first exemplary embodiment.

FIG. 6 is an example of a flowchart illustrating processing of an image forming apparatus according to a second exemplary embodiment.

FIG. 7 illustrates an example of an operation unit of an image forming apparatus according to the second exemplary embodiment.

### DESCRIPTION OF THE EMBODIMENTS

Exemplary embodiments of the disclosure will be described in detail below with reference to the accompanying drawings. However, it is to be noted that components described in the exemplary embodiments are merely examples and not intended to limit the scope of the disclosure.

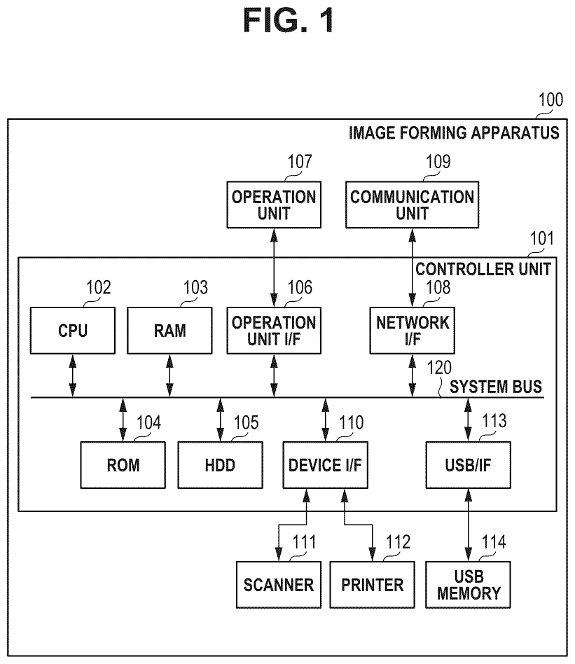

A first exemplary embodiment of the disclosure will be described below. FIG. 1 is a block diagram illustrating a hardware configuration of an image forming apparatus 100 according to the present exemplary embodiment.

The image forming apparatus 100 includes a controller unit 101, and the controller unit 101 controls a scanner 111, a printer 112, an operation unit 107, and a communication unit 109. In a case where a user uses a copy function, the controller unit 101 controls the scanner 111 to acquire image data of a document and controls the printer 112 to print an image on a sheet and to output the result. Further, in a case where the user uses a scan function, the controller unit 101 controls the scanner 111 to acquire the image data of the document, convert the image data into code data and transmit the code data to an external apparatus (not illustrated) via the communication unit 109. The code data may be image data. These pieces of data are also referred to as scanned image data. An instruction to execute processing for each of these functions is referred to as a job, and the image forming apparatus 100 executes predetermined processing in accordance with the job corresponding to each function.

The controller unit 101 includes a central processing unit (CPU) 102, a random access memory (RAM) 103, a read-only memory (ROM) 104, a hard disk drive (HDD) 105, an operation unit interface (I/F) 106, a network I/F 108, and a device I/F 110, and these components are connected to one another by a system bus 120.

The CPU 102 controls an entire system of the image forming apparatus 100. The RAM 103 is a system work memory for the CPU 102 to operate and is an image memory that temporarily stores image data. The RAM 103 also stores programs and data, such as an operating system, system software, and application software. Further, the RAM 103 stores scanned image data read by the scanner 111 and print data received from the controller unit 101 via the network. The ROM 104 stores a system boot program therein. The HDD 105 stores an operating system, system software, application software, print data, setting data, and the like. In the present exemplary embodiment, an HDD may be simply referred to as a disk.

The operation unit I/F 106 is an interface unit with the operation unit 107 and outputs to the operation unit 107 information to be displayed thereon. Further, the operation unit I/F 106 receives information that a user inputs from the operation unit 107.

The network I/F 108 is connected to the communication unit 109 and controls various communications with an external apparatus. The device I/F 110 connects the controller unit 101 to the scanner 111 and the printer 112 that read and print image data to perform input and output of image data.

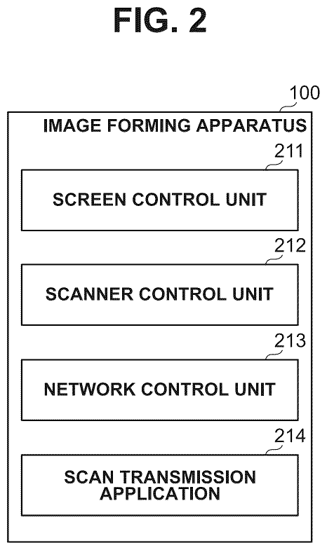

FIG. 2 is a block diagram illustrating a software configuration of the image forming apparatus 100 according to the present exemplary embodiment. Each block in FIG. 2 is software stored in the ROM 104 or the HDD 105, and the CPU 102 reads the software into the RAM 103 and executes it to realize processing in flowcharts described below.

A screen control unit 211 controls the operation unit 107 via the operation unit I/F 106. The screen control unit 211 receives information input by a user using the operation unit 107 and generates a screen to be displayed on the operation unit 107.

A scanner control unit 212 controls the scanner 111 via the device I/F 110 to read a document placed on a document platen and generate image data.

A network control unit 213 controls the communication unit 109 via the network I/F 108 to transmit image data to an external apparatus.

A scan transmission application 214 realizes an application for scanning a document and transmitting the document to an external apparatus using the screen control unit 211, the scanner control unit 212, and the network control unit 213. The scan transmission application 214 transmits acquired image data over a network in accordance with various protocols. The image data is transmitted to the network via the network control unit 213. Various protocols include transfer protocols, such as a file transfer protocol (FTP), a Server Message Block (SMB), and a simple mail transfer protocol (SMTP).

In addition, the scan transmission application 214 can also transfer image data to a Universal Serial Bus (USB) memory via a USB interface. This is referred to as Scan to USB. For example, Scan to personal computer (PC) refers to transmitting a scanned image to a USB-connected PC instead of the USB memory. Scan to PC also includes transmitting a scanned image to a network-connected PC using FTP or SMB. Scan to Email refers to following transmission to the network-connected PC. For example, a scanned image is transmitted to another PC by an e-mail using SMTP via the Internet or an intranet.

The image forming apparatus 100 may have a following specification. The image forming apparatus 100 may exclude means for explicitly clearing job setting values. For example, if a home button is pressed on the operation unit 107, a screen may simply return to a home screen, and job setting values may remain. The aspect of the embodiments is also effective for such an image forming apparatus.

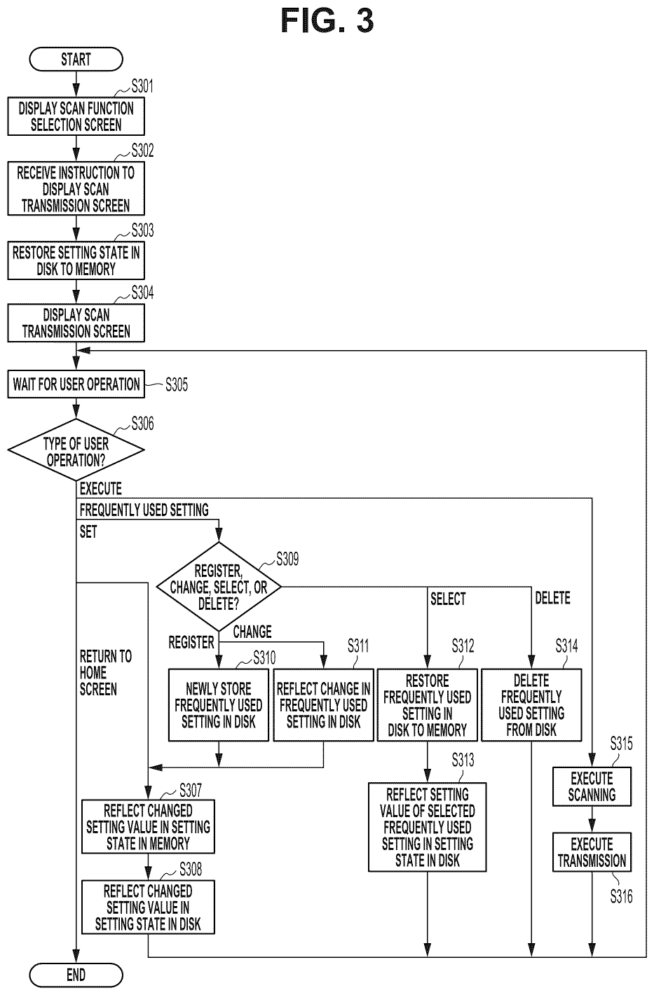

FIG. 3 is a flowchart illustrating processing for job setting value management to be executed by the image forming apparatus 100 according to the present exemplary embodiment. According to the present exemplary embodiment, how the job setting value is managed is described using the scan transmission application 214 as an example, but it is merely an example and the disclosure is not limited to this example. Copy, facsimile, and other applications may also be used. Processing in the flowchart in FIG. 3 is realized by the CPU 102 in the image forming apparatus 100 reading out a program for realizing each software module stored in the ROM 104 or the HDD 105 into the RAM 103 and executing the program.

In step S301, the scan transmission application 214 displays a scan function selection screen on the operation unit 107.

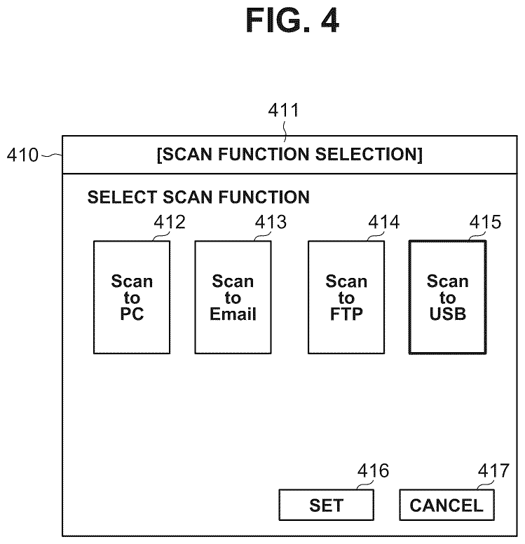

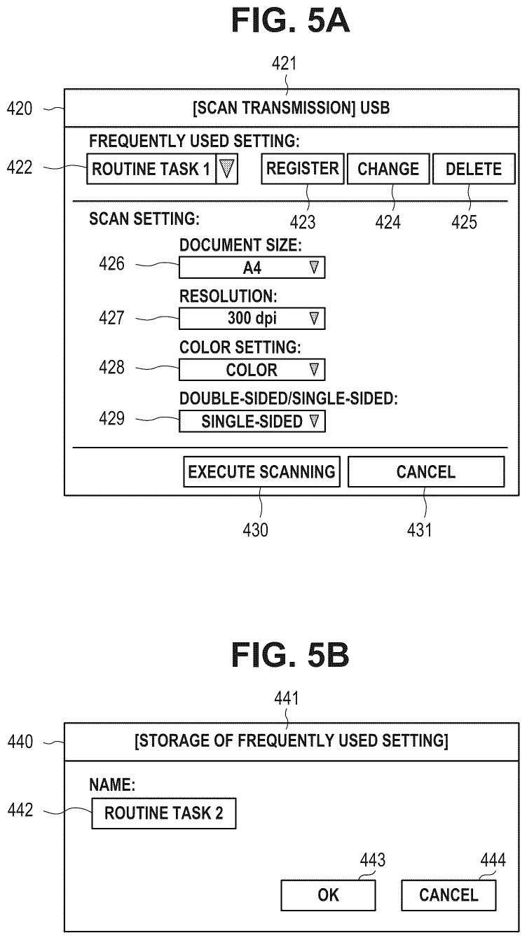

FIGS. 4 and 5A respectively illustrate an example of the scan function selection screen and a scan transmission screen displayed on the operation unit 107. The scan transmission application 214 according to the present exemplary embodiment initially selects a protocol for scan transmission, then performs a setting for the selected protocol, and operates to execute a job. FIG. 4 illustrates the scan function selection screen for prompting a user to select a scan transmission protocol that the user wants to use. FIG. 5A illustrates the scan transmission screen in a case where the protocol is “Scan to USB”. According to the present exemplary embodiment, “setting state” is defined as a set of a plurality of setting values regarding the scan transmission application 214. The scan transmission application 214 has a plurality of scan functions and can switch the setting state by switching the scan transmission protocol. The setting state of each scan transmission protocol and a type of the currently selected scan transmission protocol are controlled to be nonvolatile. “Nonvolatile” is defined as a property in which a setting value once changed is maintained as the same value unless it is explicitly changed to another value. For example, in a case where the power to the image forming apparatus 100 is turned off and on, the setting state of each scan transmission protocol and the type of the currently selected scan transmission protocol are retained in their values before the power is turned on again.

A scan function selection screen 410 illustrated in FIG. 4 includes a title 411 and a selection button 412 for a scan transmission protocol “Scan to PC”. The scan function selection screen 410 further includes a selection button 413 for a scan transmission protocol “Scan to Email”. The scan function selection screen 410 further includes a selection button 414 for a scan transmission protocol “Scan to FTP”, a selection button 415 for a scan transmission protocol “Scan to USB”, a setting button 416, and a cancel button 417. The title 411 is an area for displaying a title of the application.

The selection button 412 for the scan transmission protocol “Scan to PC” is a button to be selected in a case of setting transmission of scanned data to a PC (not illustrated). The selection button 413 for the scan transmission protocol “Scan to Email” is a button to be selected in a case of setting transmission of scanned data as an attachment to an e-mail. The selection button 414 for the scan transmission protocol “Scan to FTP” is a button to be selected in a case of setting transmission of scanned data to an FTP server (not illustrated).

Specifically, as with the scanner 111, the selection button 415 for the scan transmission protocol “Scan to USB” is a button to be selected in a case of setting transmission of scanned data to the USB memory connected to the image forming apparatus 100. A destination for transmission and a destination for storage may be a portable nonvolatile storage medium, such as a secure digital (SD) card, a flash memory, and a digital versatile disk (DVD)-RAM, instead of a USB memory.

One of the selection buttons 412 to 415 can be selected, and the selected one is displayed so that it is distinguishable as selected. As an example, in FIG. 4, the outline of the selected button and a text within are highlighted. This example illustrates that the selection button 415 for the scan transmission protocol “Scan to USB” is in a selected state. The setting button 416 is a button that is enabled in a case where any of the selection buttons 412 to 415 is selected, and if it is pressed, a setting screen for the selected scan transmission protocol is displayed. In this example, the selection button 415 for the scan transmission protocol “Scan to USB” is in the selected state, so that if the setting button 416 is pressed, a scan transmission screen 420 for the scan transmission protocol “Scan to USB” is displayed. If the cancel button 417 is pressed, the processing of the scan transmission application 214 is terminated without any operation.

The scan transmission screen 420 illustrated in FIG. 5A includes a title 421, and a registration button 423, a change button 424, and a deletion button 425 respectively used for registering, changing, and deleting a setting for selecting a frequently used setting. In addition, the scan transmission screen 420 includes select boxes 426 to 429 for selecting a document size, resolution, a color setting, and double-sided/single-sided setting, a scan execution button 430, and a cancel button 431. In a select box 422 for selecting the frequently used setting, the setting to be used can be selected from among the frequently used settings that are already registered. If a frequently used setting is selected in the select box 422, a scan setting value registered as the selected frequently used setting is restored. If no frequently used setting is selected, “unselected” is set in the select box 422. Even in this state, each of the select boxes 426 to 429 for the scan setting can be set. The registration button 423 is a button for newly registering a combination of frequently used settings with a name, and if it is pressed, a frequently used setting storing screen 440 is displayed.

The frequently used setting storing screen 440 illustrated in FIG. 5B includes a title 441, an edit box 442 for inputting a name, an OK button 443, and a cancel button 444. The edit box 442 is an edit box for inputting a name of a new frequently used setting. The OK button 443 is a button for storing the frequently used setting, and if it is pressed, a combination of scan settings selected in the select boxes 426 to 429 is stored with the name that has been input to the edit box 442. The cancel button 444 is a button for canceling the setting, and if it is pressed, the input to the edit box 442 is cancelled, and the screen is returned to the scan transmission screen 420.

Referring back to FIG. 5A, the change button 424 is a button for changing and storing details of an existing frequently used setting. Specifically, the change button 424 is a button for changing selected details in the select boxes 426 to 429 that are used for selecting scan settings. The change button 424 is used also for overwriting and storing the details of the existing frequently used setting. The deletion button 425 is a button for deleting the existing frequently used setting. In the select boxes 426 to 429 for selecting the scan settings, the user can select each of the setting details using the select boxes. The scan execution button 430 is a button for instructing a start of execution of a scan transmission job, and the cancel button 431 is a button for canceling the start of execution of the scan transmission job.

Returning to the flowchart, in step S302, the scan transmission application 214 receives an instruction to display the scan transmission screen via the screen control unit 211 based on the user pressing the setting button 416 on the scan function selection screen 410.

In step S303, the scan transmission application 214 reads the setting state stored in the HDD 105 into the RAM 103 and restores the setting state.

In step S304, the scan transmission application 214 displays the scan transmission screen reflecting the setting state in the RAM 103 on the operation unit 107.

In step S305, the scan transmission application 214 waits for a user operation via the screen control unit 211. In step S306, if a type of the detected user operation is “set”, the scan transmission application 214 advances the processing to step S307. If the type is “frequently used setting”, the scan transmission application 214 advances the processing to step S309. If the type is “execute”, the scan transmission application 214 advances the processing to step S315. Further, if the type of the detected user operation is “return to home screen”, the scan transmission application 214 terminates the processing in the flowchart. The type of user operation “set” includes an operation for performing a setting regarding the scan transmission job, such as changing the document size, resolution, or the color setting. The type of user operation “frequently used setting” includes an operation for switching the frequently used setting based on an operation on the select box 422, an operation for newly registering the frequently used setting, an operation for changing or deleting the existing setting. The type of user operation “execute” is an operation equivalent to pressing the scan execution button 430. The type of user operation “return to home screen” is an operation to return to the home screen from the scan transmission screen and corresponds to, for example, pressing a home button (not illustrated) provided as a physical button on the operation unit 107.

In step S307, the scan transmission application 214 reflects the setting value changed based on the user operation in the setting state in the RAM 103. In step S308, the scan transmission application 214 reflects the setting value changed based on the user operation in a file in the HDD 105 that stores the current setting state.

In step S309, in a case where the type of the detected user operation is selection of the frequently used setting in the select box 422 (“SELECT” in step S309), the scan transmission application 214 advances the processing to step S312. In a case where the type is new registration of the frequently used setting which is selected by pressing the registration button 423, inputting a name in the edit box 442, and then pressing the OK button 443 (“REGISTER” in step S309), the scan transmission application 214 advances the processing to step S310. In a case of pressing the change button 424 (“CHANGE” in step S309), the scan transmission application 214 advances the processing to step S311. In a case of pressing the deletion button 425 (“DELETE” in step S309), the scan transmission application 214 advances the processing to step S314. In step S312, the scan transmission application 214 reads the frequently used setting selected by the user and stored in the HDD 105 into the RAM 103 to restore the frequently used setting. Next, in step S313, the scan transmission application 214 stores the frequently used setting selected by the user in a file in the HDD 105 as the current setting value and advances the processing to step S305. In step S310, the scan transmission application 214 stores the combination of setting values of the newly registered frequently used setting in the HDD 105 and advances the processing to step S307. In step S311, the scan transmission application 214 stores the combination of setting values of the changed frequently used setting in the HDD 105 and advances the processing to step S307. In step S314, the scan transmission application 214 deletes the combination of setting values of the frequently used setting that is specified to be deleted from the HDD 105 and advances the processing to step S305.

In step S315, the scan transmission application 214 executes scanning using the scanner 111 in accordance with the setting state stored in the RAM 103 via the scanner control unit 212 to generate scanned image data. During the operation in step S315, the scan transmission application 214 displays a dialog (not illustrated) to inform the user that scanning is being executed on the scan transmission screen. In step S316, the scan transmission application 214 transmits the scanned image data to the USB memory in accordance with the setting state stored in the RAM 103 via the network control unit 213. During the operation in step S316, the scan transmission application 214 displays a dialog (not illustrated) to inform the user that transmission processing is being performed on the scan transmission screen.

As described above, according to the procedures described in the present exemplary embodiment, in a case where there is a plurality of setting patterns for each protocol to be repeatedly executed, the protocols can be executed with the setting patterns not being reset each time, so that usability is improved.

A second exemplary embodiment will be described focusing on differences from the first exemplary embodiment. According to the above-described exemplary embodiment, the setting states of frequently used settings for each scan transmission protocol are all controlled to be nonvolatile. Accordingly, the setting state can be restored by simply switching the scan transmission protocol, and repeated execution can be performed with the setting states not being reset each time. However, a current setting for each scan transmission protocol cannot be known on a scan function selection screen and cannot be known until a user advances the processing to the scan transmission screen. Thus, in the second exemplary embodiment, a configuration is described in which a current setting for each scan transmission protocol can be known at the time when the scan function selection screen is displayed.

Since the second exemplary embodiment is a modification of the first exemplary embodiment, only differences will be described.

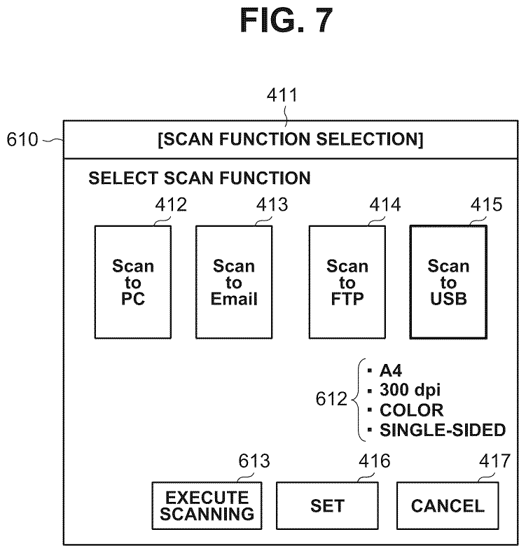

FIG. 7 illustrates a scan transmission screen 610. Only differences from FIG. 4 will be described. FIG. 7 illustrates an example in which a setting state 612 for each currently enabled scan transmission protocol is displayed. In this example, the current setting state for the scan transmission protocol “Scan to USB” can be seen at a glance, where the state indicates that document size is A4, the resolution is 300 dpi, the color setting is color, and double-sided/single-sided setting is single-sided. Thus, if there is no need to change the settings on the scan transmission screen 420, scanning can be executed with the current setting state by the user pressing a scan execution button 613.

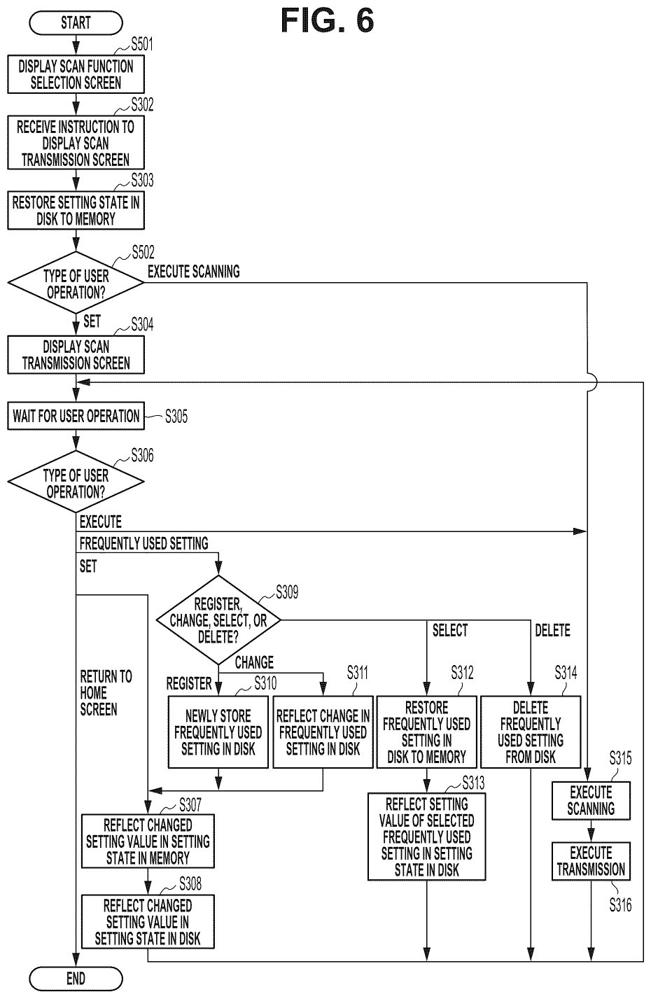

FIG. 6 is a flowchart illustrating processing for job setting value management to be executed by the image forming apparatus 100 according to the second exemplary embodiment. FIG. 6 illustrates a flowchart modified from that in FIG. 3. Only differences from FIG. 3 are described.

The flowchart in FIG. 6 is realized by the CPU 102 in the image forming apparatus 100 reading out a program for realizing each software module stored in the ROM 104 or the HDD 105 into the RAM 103 and executing the program. The program is also referred to as a control program.

In step S501, the scan transmission application 214 displays the scan function selection screen on the operation unit 107. At this time, the scan transmission application 214 reads the setting state stored in the HDD 105 for each scan transmission protocol into the RAM 103 and displays the scan function selection screen on the operation unit 107 as illustrated in the setting state 612.

In step S502, in a case where the user presses the setting button 416 on the scan function selection screen 410 (SET in step S502), the scan transmission application 214 advances the processing to step S304 and displays the scan transmission screen 420. However, if the user checks the setting state 612 for each scan transmission protocol currently enabled on the scan function selection screen 410 and executes scanning with this setting, in other words, in a case where the scan execution button 613 is pressed (EXECUTE SCANNING in step S502), the scan transmission application 214 advances the processing to step S315 and executes scanning.

As described above, according to the procedures described in the present exemplary embodiment, a job that is executed repeatedly with the same setting can be executed with the setting not being reset each time, and a currently enabled setting state can be easily checked, thus improving usability.

As described above, the HDD 105 is disclosed that serves as an example of a storage unit storing, as composite settings, a plurality of settings of the image forming apparatus 100 capable of transmitting an image in a plurality of methods.

The CPU 102 selects one composite setting from among the composite settings stored in the HDD 105.

Selection can be performed using the screens illustrated in FIGS. 4, 5A, and 5B. It has been described that the composite settings, for example, routine tasks illustrated in FIGS. 4, 5A and 5B are defined for each of the plurality of methods. The method is a communication method illustrated in FIGS. 4, 5A, and 5B. As described in the example of Scan to USB, the method for transmitting an image includes transferring an image from the HDD 105 of the image forming apparatus 100 to a nonvolatile memory via a USB I/F 113 under the control of the CPU 102. An example of a nonvolatile memory includes a USB memory 114.

The CPU 102 changes a setting value for each function included in one composite setting selected by a user interface (UI) in FIGS. 4, 5A, and 5B.

The CPU 102 deletes one composite setting from among a plurality of composite settings stored in the HDD 105. The image forming apparatus 100 executes an image forming job. Further, the image forming apparatus 100 displays the composite settings stored in the HDD 105 for the function used in the job. An example of a display unit is the operation unit 107. Examples of image forming jobs include a scan job, a copy job, and a print job.

The plurality of methods includes a method for transmitting an acquired image to an information processing apparatus via a predetermined communication interface. Further, there is a method for attaching an image to an e-mail and transmitting it to an information processing apparatus. Furthermore, there is a method for transferring and storing an image in a predetermined nonvolatile memory. For example, the composite setting can be defined for at least two of these methods. The plurality of methods includes, for example, “Scan to USB”, “Scan to PC”, and “Scan to Email”. An example of a computer is the CPU 102.

The above described exemplary embodiment according to the present disclosure include the following configurations.

(Configuration 1) An image forming apparatus configured to transmit an image in a plurality of methods, the image forming apparatus including a storage unit configured to store a plurality of settings of the image forming apparatus as composite settings, and a selection unit configured to select one composite setting from among the composite settings stored in the storage unit, wherein the composite settings are defined for each of the plurality of methods.
(Configuration 2) The image forming apparatus according to configuration 1, further including a change unit configured to change a setting value for each function included in the one composite setting selected by the selection unit; and a deletion unit configured to delete one composite setting from among the composite settings stored in the storage unit.
(Configuration 3) The image forming apparatus according to configuration 1, wherein the image forming apparatus is configured to execute a job for forming an image and further comprises a display unit configured to display the composite settings stored in the storage unit for a function to be used for the job.
(Configuration 4) The image forming apparatus according to configuration 1, wherein the plurality of methods includes at least two of a method for transmitting an acquired image to an information processing apparatus via a predetermined communication interface, a method for attaching the acquired image to an e-mail and transmitting the e-mail to an information processing apparatus, and a method for transferring the acquired image to a predetermined nonvolatile memory and storing the acquired image in the predetermined nonvolatile memory.
(Configuration 5) A method for controlling an image forming apparatus configured to transmit an image in a plurality of methods, the method including storing a plurality of settings of the image forming apparatus as composite settings, and selecting one composite setting from among the composite settings stored in the storing, wherein the composite settings are defined for each of the plurality of methods.
(Configuration 6) The method according to configuration 5, further including changing a setting value for each function included in the one composite setting selected in the selecting, and deleting one composite setting from among the composite settings stored in the storing.
(Configuration 7) The method according to configuration 5, wherein the image forming apparatus is configured to execute a job for forming an image, and the method further comprises displaying the composite settings stored in the storing for a function to be used for the job.
(Configuration 8) The method according to configuration 5, wherein the plurality of methods includes at least two of a method for transmitting an acquired image to an information processing apparatus via a predetermined communication interface, a method for attaching the acquired image to an e-mail and transmitting the e-mail to an information processing apparatus, and a method for transferring the acquired image to a predetermined nonvolatile memory and storing the acquired image in the predetermined nonvolatile memory.
(Configuration 9) A storage medium storing a program for causing a computer to perform a method, according to any one of configurations 5 to 8, for controlling an image forming apparatus.

According to an aspect of the embodiments, it is possible to handle a composite setting that includes a plurality of settings.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-009511, filed Jan. 25, 2024, which is hereby incorporated by reference herein in its entirety.

What is claimed is:

1. An apparatus configured to transmit an image in a plurality of methods, the apparatus comprising:
a storage unit configured to store a plurality of settings of the apparatus as composite settings; and
a selection unit configured to select one composite setting from among the composite settings stored in the storage unit,
wherein the composite settings are defined for each of the plurality of methods.

2. The apparatus according to claim 1, further comprising:
a change unit configured to change a setting value for each function included in the selected one composite setting; and
a deletion unit configured to delete one composite setting from among the composite settings stored in the storage unit.

3. The apparatus according to claim 1, wherein the apparatus is configured to execute a job for forming an image and further comprises a display unit configured to display the composite settings stored in the storage unit for a function to be used for the job.

4. The apparatus according to claim 1, wherein the plurality of methods includes at least two of a method for transmitting an acquired image to a processing apparatus via a predetermined communication interface, a method for attaching the acquired image to an e-mail and transmitting the e-mail to the processing apparatus, and a method for transferring the acquired image to a predetermined nonvolatile memory and storing the acquired image in the predetermined nonvolatile memory.

5. A method for controlling an apparatus configured to transmit an image in a plurality of methods, the method comprising:
storing a plurality of settings of the apparatus as composite settings; and
selecting one composite setting from among the stored composite settings,
wherein the composite settings are defined for each of the plurality of methods.

6. The method according to claim 5, further comprising:
changing a setting value for each function included in the selected one composite setting; and
deleting one composite setting from among the stored composite settings.

7. The method according to claim 5, wherein the apparatus is configured to execute a job for forming an image, and the method further comprises displaying the stored composite settings for a function to be used for the job.

8. The method according to claim 5, wherein the plurality of methods includes at least two of a method for transmitting an acquired image to a processing apparatus via a predetermined communication interface, a method for attaching the acquired image to an e-mail and transmitting the e-mail to the processing apparatus, and a method for transferring the acquired image to a predetermined nonvolatile memory and storing the acquired image in the predetermined nonvolatile memory.

9. A storage medium storing a program for causing a computer to perform a method for controlling an apparatus, the method comprising:
storing a plurality of settings of the apparatus as composite settings; and
selecting one composite setting from among the stored composite settings,
wherein the composite settings are defined for each of the plurality of methods.

10. The storage medium according to claim 9, further comprising:
changing a setting value for each function included in the selected one composite setting; and
deleting one composite setting from among the stored composite settings.

11. The storage medium according to claim 9, wherein the apparatus is configured to execute a job for forming an image, and the method further comprises displaying the stored composite settings for a function to be used for the job.

12. The storage medium according to claim 9, wherein the plurality of methods includes at least two of a method for transmitting an acquired image to a processing apparatus via a predetermined communication interface, a method for attaching the acquired image to an e-mail and transmitting the e-mail to the processing apparatus, and a method for transferring the acquired image to a predetermined nonvolatile memory and storing the acquired image in the predetermined nonvolatile memory.
